(19) United States
(12) Patent Application Publication
(10) Pub. No.: US 2013/0083652 A1
(43) Pub. Date: Apr. 4, 2013

(54) APPARATUS AND METHOD OF SHARED MESH PROTECTION SWITCHING

(71) Applicant: Electronics and Telecommunications Research Institute, Daejeon (KR)

(72) Inventors: Taesik CHEUNG, Daejeon (KR); Jeong-dong RYOO, Daejeon (KR)

(73) Assignee: Electronics and Telecommunications Research Institute, Daejeon (KR)

(21) Appl. No.: 13/630,539

(22) Filed: Sep. 28, 2012

(30) Foreign Application Priority Data
Sep. 29, 2011 (KR) 10-2011-0098813
Sep. 28, 2012 (KR) 10-2012-0109229

(51) Int. Cl. H04L 29/14; H04L 12/56

(52) U.S. Cl. 370/228

(57) ABSTRACT

A method of performing protection switching in which congestion does not occur at a shared segment and that can rapidly perform linear protection switching while using an 1-phase automatic protection switching protocol is provided. An end node that requests protection switching awaits by a time that is previously set to a timer and stops use of a shared protection segment for a standby time of the end node and thus traffic that is injected to a shared node reduces, whereby a congestion situation of a shared protection segment does not occur and thus a protection switching protocol is prevented from abnormally operating.

### CROSS-REFERENCE TO RELATED APPLICATION

This application claims priority to and the benefit of Korean Patent Application No. 10-2011-0098813 and 10-2012-0109229 filed in the Korean Intellectual Property Office on Sep. 29, 2011 and Sep. 28, 2012, the entire contents of which are incorporated herein by reference.

### BACKGROUND OF THE INVENTION

(a) Field of the Invention

The present invention relates to shared mesh protection switching that shares a protection path.

(b) Description of the Related Art

Protection switching is a method of resuming traffic transmission when traffic transmission is stopped, as a signal failure occurs in a network. A protection switching method is classified into linear protection switching, ring protection switching, and mesh protection switching according to topology of a network.

Linear protection switching operates within a linear protection domain. That is, in a linear protection switching method, both end nodes that send and receive traffic and a working path and a protection path that connect the both end nodes are defined as a linear protection domain, and by transmitting/receiving a message between end nodes according to a protocol, a protection switching function operates.

When a plurality of point-to-point connections are formed on a mesh topology network, mesh protection switching sets a linear protection domain for a point-to-point connection one by one and enables protection paths of a plurality of linear protection domains to share the same network resource.

That is, mesh protection switching provides a mechanism by which a plurality of linear protection domains efficiently coordinates the use of a network resource, when the plurality of linear protection domains having different end nodes exists in a mesh topology network.

An International Telecommunication Union-Telecommunication standardization sector (ITU-T) is performing standardization of shared mesh protection switching as a generic shared mesh protection switching (G.smp), and International Engineering Task Force (IETF) is discussing shared mesh protection switching for Multi-Protocol Label Switching (hereinafter, referred to as ‘MPLS’)-Transport Profile (TP).

A shared mesh protection switching method (PCT/KR2010/009295) provides the same protection switching time as that of conventional one-to-one linear protection switching. The shared mesh protection switching method includes step of using a linear protection switching protocol between end nodes, but of requesting to stop use of a shared protection segment that is included in a protection path to an end node of a protection path that is included in an end-to-end linear protection domain having a lower priority.

In this case, one-to-one (1:1) linear protection switching that is used in a shared mesh protection switching method uses an 1-phase automatic protection switching (hereinafter, referred to as ‘APS’) protocol that is used in a packet network such as Ethernet and MPLS and thus rapidly performs protection switching.

That is, an end node in which a signal failure is detected at a working path or that receives a protection switching command from an operator first performs protection switching regardless of a response of a far-end node, informs the fact that the protection switching has been performed to the far-end node through an APS message, and reports a protection switching event to a shared node. The shared node compares a priority of an end-to-end linear protection domain including a protection path corresponding to a working path in which a protection switching event is detected with a priority of an end-to-end linear protection domain including another protection path that shares a protection segment. As the result of priority comparison, the shared node requests prohibiting of protection switching to an end node that is connected to a protection path that is included in an end-to-end linear protection domain having the same or lower priority. Thereafter, the end node that receives the request from the shared node starts a process to prohibit a protection switching according to APS protocol.

As described above, because an end node which has detected a protection switching event reports the protection switching event and simultaneously switches traffic to the protection path, a congestion situation in which traffic exceeding a bandwidth of a shared protection segment is instantaneously injected to the shared protection segment of the protection path may occur.

Further, when congestion occurs at the shared protection segment, a continuity check (CC) message that is sent and received between end nodes in order to monitor a state of a protection path between the end nodes is lost and thus it may be determined that the protection path between the end nodes is in a signal failure. In this case, because a signal failure of a protection path generally has a higher priority than that of a working path, protection switching to the protection path is canceled and thus a problem that a shared mesh protection switching mechanism erroneously operates may occur.

### SUMMARY OF THE INVENTION

The present invention has been made in an effort to provide a method of performing shared mesh protection switching having advantages of enabling a congestion situation not to occur at a shared protection segment and to smoothly perform protection switching to the protection path by reducing traffic that is injected to a shared node before a protection switching process to the protection path is performed.

An exemplary embodiment of the present invention provides a method of performing protection switching of an end node, having detected a signal failure of a working path among end node pairs that are connected by the working path and a protection path, the method comprising: reporting, when a signal failure of the working path is detected, a protection switching event to a shared node on the protection path; waiting for a preset time, after the protection switching event is reported; and completing, when the preset time has elapsed, protection switching to the protection path with the remaining end nodes of the end node pair.

Another embodiment of the present invention provides a method of performing protection switching of a shared node that is shared by a plurality of protection path comprising first and second protection paths, the method comprising: receiving a report of a protection switching event from an end node, having detected a signal failure of a working path corresponding to the first protection path; requesting, when the second protection path uses the shared node, to stop protection switching to at least one end node of end node pairs that are connected by the second protection path; and receiving a report of protection switching lock-out completion from at least one end node of end node pairs that are connected by the second protection path.

Yet another embodiment of the present invention provides an end node that performs protection switching in end node pairs that are connected by a working path and a protection path, the end node comprising: a signal failure detection unit that detects a signal failure of the working path; a timer unit that performs wait-to-pre-emption of the end node for a preset time; and a controller that reports a protection switching event through the protection path and that operates the timer unit, when the signal failure detection unit detects a signal failure of the working path.

### BRIEF DESCRIPTION OF THE DRAWINGS

FIG. 1 is a diagram illustrating a network in which one-direction signal failure has occurred at a plurality of working paths according to an exemplary embodiment of the present invention.

FIG. 2 is a block diagram illustrating a configuration of a node that performs shared protection switching according to an exemplary embodiment of the present invention.

FIG. 3 is a flowchart illustrating a shared protection switching process when a unidirectional signal failure has occurred at a plurality of working paths according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise” and variations such as “comprises” or “comprising”, will be understood to imply the inclusion of stated elements but not the exclusion of any other elements.

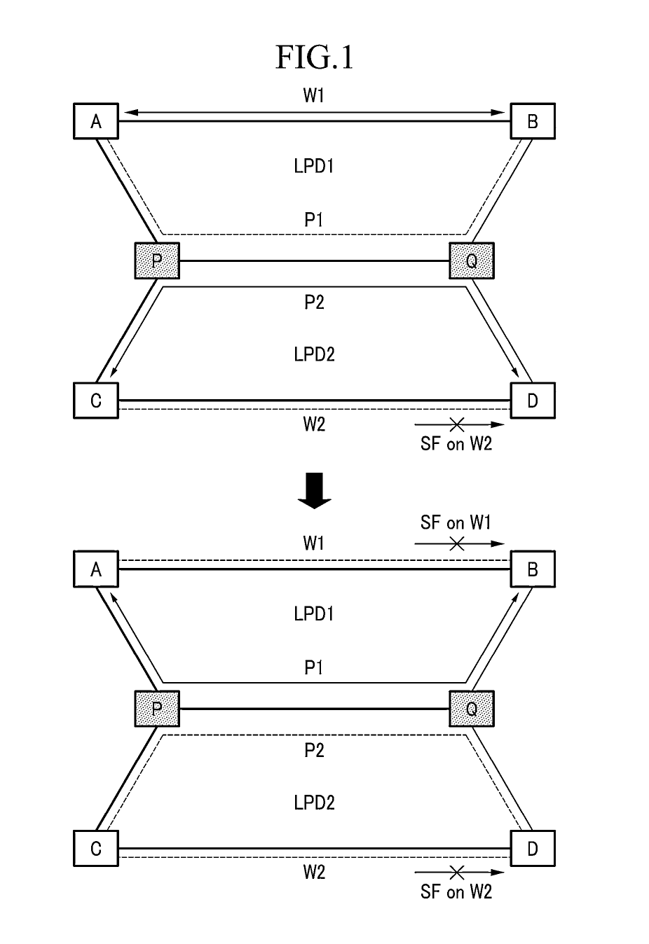

FIG. 1 is a diagram illustrating a network in which a unidirectional signal failure has occurred at a plurality of working paths according to an exemplary embodiment of the present invention.

In an exemplary embodiment of the present invention, a shared mesh protection domain includes a plurality of end node pairs and a plurality of shared nodes. Such a network may be various networks such as an Ethernet network, a provider backbone bridge-traffic engineering (PBB-TE) network, and an MPLS network.

Referring to FIG. 1, in an exemplary embodiment of the present invention, an end node A and an end node B are connected by a working path W1 and a protection path P1. An end node C and an end node D are connected by a working path W2 and a protection path P2.

A linear protection domain 1 (hereinafter, referred to as an ‘LPD1’) includes a working path W1 and a protection path P1, and a linear protection domain 2 (hereinafter, referred to as an ‘LPD2’) includes a working path W2 and a protection path P2. The protection path P1 and the protection path P2 share shared nodes P and Q and a shared segment P-Q.

In an exemplary embodiment of the present invention, it is assumed that each of end node pairs A and B, and C and D operates by a bidirectional protection switching method according to a one-to-one linear protection switching protocol.

Further, after a signal failure (SF) has first occurred at the working path W2, another signal failure (SF) occurs at the working path W1, and in an exemplary embodiment of the present invention, it is assumed that that a priority of a linear protection domain is LPD1>LPD2.

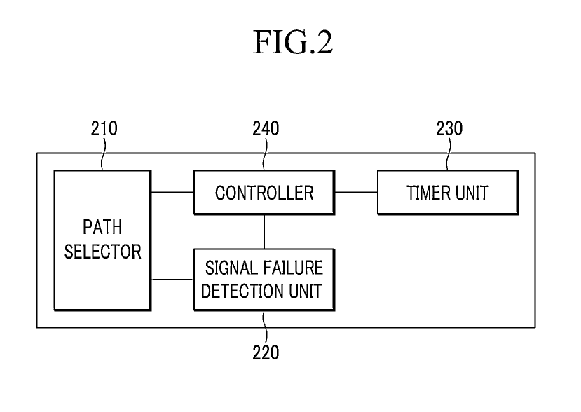

FIG. 2 is a block diagram illustrating a configuration of a node that performs shared protection switching according to an exemplary embodiment of the present invention.

Referring to FIG. 2, the node that performs shared protection switching according to an exemplary embodiment of the present invention includes a path selector 210, a signal failure detection unit 220, a timer unit 230, and a controller 240.

The path selector 210 includes a physical connection unit (not shown) that connects the node to a working path or a protection path according to the control of the controller 240 and that connects the node to the working path or the protection path.

The signal failure detection unit 220 detects a signal failure of the working path or the protection path and reports the signal failure to the controller 240. The signal failure detection unit 220 may be a constituent element of the controller 240.

When a signal failure occurs at the working path, by stopping signal transmission of the node for a preset time according to the control of the controller 240, until protection switching to the protection path is started, the timer unit 230 performs wait-to-pre-emption (WTP) of the node. The timer unit 230 may be a constituent element of the controller 240.

The controller 240 controls traffic that is transmitted/received through a working path and a protection path and controls a path selection of the path selector 210. Further, when the signal failure detection unit 220 detects a signal failure of the working path, if a report in which a signal failure has occurred at the working path is received from the signal failure detection unit 220, the controller 240 reports a protection switching event through the protection path, and operates the timer unit 230, thereby performing WTP of the node.

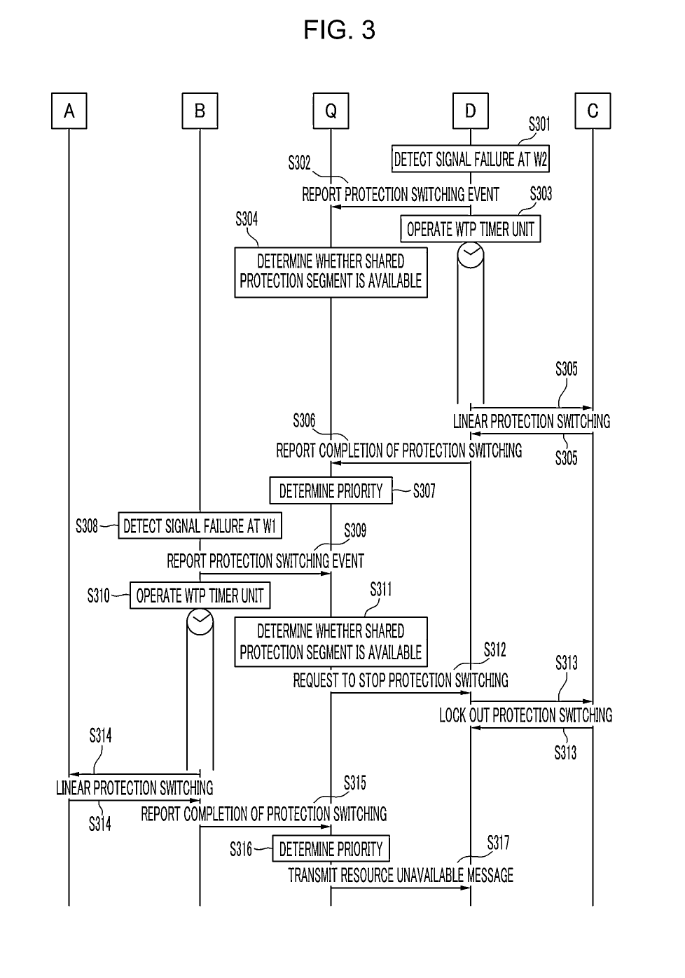

FIG. 3 is a flowchart illustrating a shared protection switching process when a unidirectional signal failure has occurred at a plurality of working paths according to an exemplary embodiment of the present invention.

Referring to FIG. 3, an end node D first detects a signal failure at the working path W2 (S301) and reports a protection switching event to the shared node Q on the protection path P2 for protection switching to the protection path P2 (S302). In this case, a protection switching event performs a function of notifying the shared node that protection switching to the protection path will be performed when an event to perform protection switching to the protection path occurs.

Further, the end node D operates the timer unit 230 (S303), and until the timer unit 230 is terminated, the end node D transmits no signal for a preset time and stands by.

In this case, the end node D may operate the timer unit 230 while reporting a protection switching event and operate the timer unit 230 while detecting a signal failure. That is, after the end node D detects a signal failure, at any moment before a process of reporting a protection switching event, the end node D may operate the timer unit 230.

In this case, a ‘preset time’ of the timer unit 230 may be previously set by a network operator in consideration of an average arrival time of a response to a protection switching event report or an average protection switching lock-out time of another end node pair using a shared node.

Conventionally, an end node which has detected a signal failure of a working path reports protection switching to a shared node, connects a path selector to a protection path, and transmits an automatic protection switching (APS) message and that requests protection switching to a far-end node. However, in this case, if shared protection segment have been already used by a protection path having a lower priority, congestion may occur at a shared protection segment until the use of the shared protection segment is stopped.

As described above, when congestion occurs at the shared protection segment, the end node that requests protection switching may detect that a signal failure exists at the protection path. In this case, because a signal failure of the protection path has a priority higher than that of the working path, the end node transmits a protection switching cancel event to the shared node and cancels the protection switching. That is, even if a signal failure does not occur at the protection path, as the end node wrongly recognizes that a signal failure has occurred at the protection path and cancels the protection switching, an error in which protection switching is not performed may occur.

According to an exemplary embodiment of the present invention, an end node, having detected a signal failure at a working path requests protection switching to a shared node and performs WTP by a preset time by operating the timer unit 230. Thereby, because only a message for enabling to terminate use of a shared protection segment passes through the shared protection segment, a congestion occurrence possibility at the shared protection segment can be remarkably reduced.

Thereafter, the shared node Q, having received a protection switching event from the end node D determines whether a shared protection segment P-Q including the shared node Q is available (S304).

In FIG. 1, when the end node D reports a protection switching event, there is no end node that uses the shared protection segment P-Q, and thus after a time that is set to the timer unit 230 is terminated, the end node D performs protection switching to the protection path P2 according to a linear protection switching protocol (S305).

Each of end node pairs that complete linear protection switching to the protection path reports completion of protection switching to a connected shared node (S306). Referring to FIG. 1, the end node C reports completion of protection switching to the shared node P, and the end node D reports completion of protection switching to the shared node Q.

The shared node, having received the report of completion of protection switching from the end node determines a priority of a protection path including the shared node (S307) and transmits a resource unavailable message to an end node that is connected to a protection path of a lower priority according to a determination result.

Referring to FIGS. 1 and 3, in two protection paths P1 and P2 including the shared node Q, the protection path P1 that does not presently use the shared node has a higher priority and thus the shared node Q does not transmit a resource unavailable message to the end node B.

Thereafter, a signal failure occurs at the working path W1. The end node B detects a signal failure at the working path W1 (S308), reports a protection switching event to the shared node Q for protection switching to the protection path P1 (S309), and operates the timer unit 230 (S310).

In this case, until the timer unit 230 is terminated, the end node B transmits no signal for a preset time.

Thereafter, the shared node Q, having received the protection switching event from the end node B determines whether a shared protection segment P-Q including the shared node Q is available (S311). In this case, if a shared protection segment is used by a linear protection domain having a lower priority, the shared node requests to stop use of the shared protection segment to an end node that is positioned at both ends of the protection path.

In FIG. 1, when the end node B reports a protection switching event, the end nodes C and D use the shared protection segment P-Q. Therefore, the shared node Q compares priorities of the working paths W1 and W2 and requests stop of protection switching to the end node D that is connected to the working path W2 having a lower priority (S312).

The end node D, having received the protection switching stop request from the shared node Q locks out protection switching to the protection path P2 according to a linear protection switching protocol and stops use of the protection path (S313). In this case, a consumed time from when a signal failure has occurred at the working path W1 to when protection switching to the protection path P2 is locked out is recorded and reported to a network operator. As described above, the network operator may input a ‘preset time’ of the WTP timer unit 230 by averaging a consumed time from when a signal failure has occurred at the working path to when protection switching of a protection path that is used by another end node is locked out or reflecting a maximum time thereof.

Thereafter, after a preset time of the timer unit 230 has elapsed, the end node B performs protection switching according to a linear protection switching protocol (S314).

Each of end node pairs that complete linear protection switching to the protection path reports completion of protection switching to a connected shared node (S315). Referring to FIG. 1, the end node A reports completion of protection switching to the shared node P, and the end node B reports completion of protection switching to the shared node Q.

The shared node, having received a report of completion of protection switching from the end node determines a priority of a protection path including the shared node (S316) and transmits a resource unavailable message to an end node that is connected to a protection path of a lower priority according to a determination result (S317).

Referring to FIGS. 1 and 2, in two protection paths P1 and P2 including the shared node Q, because a priority of the protection path P2 using a present shared node is low, the shared node Q transmits a resource unavailable message to the end node D.

In this case, even if a signal failure is detected at a working path, until the end node receives a resource available message from the shared node, the end node, having received a resource unavailable message from the shared node does not report a protection switching event to the shared node and does not operate the timer unit 230.

That is, when the end node does not receive a resource unavailable message from the shared node or receives a resource available message from the shared node, the end node, having detected a signal failure reports a protection switching event to the shared node and operates the timer unit 230.

As described above, according to an exemplary embodiment of the present invention, an end node that requests protection switching awaits by a time that is preset to a timer, stops use of a shared protection segment for a standby time of the end node and thus a congestion occurrence possibility of the shared protection segment decreases.

That is, while a shared node that is connected to the shared protection segment stops use of a protection path of an end node that is connected to a working path having a lower priority, an end node that is connected to a working path having a higher priority stands by through a timer, whereby an abnormal operation of a shared mesh protection switching protocol due to a protection path signal failure that may occur when a message for stopping use of a protection path of the end node that is connected to the working path having a lower priority and a message for using a protection path of the end node that is connected to the working path having a higher priority collide can fundamentally be prevented.

Further, by separating and defining a process of arbitrating use of a shared protection segment and a process of actually performing protection switching, conventional 1-phase linear protection switching can be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of performing protection switching of an end node, having detected a signal failure of a working path among end node pairs that are connected by the working path and a protection path, the method comprising:
reporting, when a signal failure of the working path is detected, a protection switching event to a shared node on the protection path;
waiting for a preset time, after the protection switching event is reported; and
completing, when the preset time has elapsed, protection switching to the protection path with the remaining end nodes of the end node pair.

2. The method of claim 1, wherein the shared node is shared by the protection path and at least one protection path that connects another end node pair.

3. The method of claim 2, wherein the end node, having detected a signal failure of the working path receives a resource available message from the shared node and reports the protection switching event, when the protection path has a priority lower than that of the at least one protection path.

4. The method of claim 2, wherein the end node, having detected a signal failure of the working path reports the protection switching event regardless of whether a resource of the at least one protection path is available, when the protection path has a priority higher than that of the at least one protection path.

5. The method of claim 2, wherein the preset time is determined based on a time that is consumed when the shared node locks out to use the shared node of the at least one protection path.

6. The method of claim 1, further comprising reporting completion of protection switching to the protection path to the shared node, after the completing of protection switching.

7. A method of performing protection switching of a shared node that is shared by a plurality of protection path comprising first and second protection paths, the method comprising:
receiving a report of a protection switching event from an end node, having detected a signal failure of a working path corresponding to the first protection path;
requesting, when the second protection path uses the shared node, to stop protection switching to at least one end node of end node pairs that are connected by the second protection path; and
receiving a report of protection switching lock-out completion from at least one end node of end node pairs that are connected by the second protection path.

8. The method of claim 7, further comprising,
before the receiving of a report of a protection switching event,
transmitting, by the shared node, a resource available message to an end node, having detected a signal failure at a working path corresponding to the first protection path, when the first protection path has a priority lower than that of at least one of the plurality of protection paths.

9. An end node that performs protection switching in end node pairs that are connected by a working path and a protection path, the end node comprising:
a signal failure detection unit that detects a signal failure of the working path;
a timer unit that performs wait-to-pre-emption of the end node for a preset time; and
a controller that reports a protection switching event through the protection path and that operates the timer unit, when the signal failure detection unit detects a signal failure of the working path.

10. The end node of claim 9, wherein the controller receives a resource unavailable message and a resource available message from a shared node on the protection path.

11. The end node of claim 9, wherein the controller completes protection switching to the protection path with the remaining end node of the end node pair, when the preset time has elapsed.

12. The end node of claim 11, wherein the controller reports completion of protection switching to the protection path to a shared node that is positioned on the protection path, after protection switching to the protection path is complete.

13. The end node of claim 9, wherein the preset time is determined based on a time that is consumed when use of the shared node is locked out by at least one of a plurality of protection paths that connect the end node and another end node pair and that share the shared node.
